(19) United States
(12) Patent Application Publication
(10) Pub. No.: US 2020/0249173 A1
(43) Pub. Date: Aug. 6, 2020

(54) COLORIMETRIC SENSOR FOR DETECTING NICKEL ION USING SILVER NANO PRISM ETCHING, A METHOD FOR PRODUCING THE SAME, AND A COLORIMETRIC DETECTION METHOD OF A NICKEL ION USING THE SAME

(71) Applicant: KOREA INSTITUTE OF SCIENCE AND TECHNOLOGY, Seoul (KR)

(72) Inventors: Kang Bong LEE, Seoul (KR); Yun Sik NAM, Seoul (KR); Yeon Hee LEE, Seoul (KR); Sujin YOON, Seoul (KR)

(21) Appl. No.: 16/745,359

(22) Filed: Jan. 17, 2020

(30) Foreign Application Priority Data
Feb. 1, 2019 (KR) 10-2019-0013450

(51) Int. Cl. G01N 21/78

(52) U.S. Cl. CPC G01N 21/78; B82Y 15/00

(57) ABSTRACT

The present disclosure relates to a colorimetric sensor for detecting nickel ions using nanoprism etching, a method for producing the same, and a colorimetric detection method of nickel ions using the same. More specifically, the present disclosure relates to a colorimetric sensor for detecting nickel ions, which uses non-modified silver nanoprisms (AgNPRs), whose surfaces have not been modified, so that the nanoprisms are etched selectively only by nickel ions (Ni²⁺), leading to a color change and thus allowing to detect nickel ions (Ni²⁺), a method for producing the same, and a colorimetric detection method of nickel ions using the same.

### DESCRIPTION OF GOVERNMENT-FUNDED RESEARCH AND DEVELOPMENT

This research is made by Korean Institute of Science and Technology and funded by Korea Environmental Industry & Technology Institute, Ministry of Environment of the Republic of Korea. Research project is Environmental Policy Based Public Technology Development Project, and project name is development of real-time on-site detection technology for bioaerosol and harmful heavy metal components in ultra fine dust and fine dust (Project Serial Number: 1485014814).

### CROSS-REFERENCE TO RELATED APPLICATION

This application claims priority to Korean Patent Application No. 10-2019-0013450, filed on Feb. 1, 2019, and all the benefits accruing therefrom under 35 U.S.C. § 119, the contents of which in its entirety are herein incorporated by reference.

### BACKGROUND OF THE INVENTION

### Field of the Invention

Disclosed herein are a colorimetric sensor for detecting nickel ions using nanoprism etching, a method for producing the same, and a colorimetric detection method of nickel ions using the same.

### Description of the Related Art

Nickel is a metal element widely used in various industries such as coin and jewelry manufacturing, battery manufacturing and electroplating technology. However, when nickel residues come in contact with the body, they may cause allergies, which may lead to lung inflammation or dermatitis [J. Am, Dent. Assoc. 118, 449 (1989)]. The International Agency for Research on Cancer classified nickel as a human carcinogen [IARC (International Agency for Research on Cancer), 1990].

The maximum allowable nickel ion (Ni²⁺) concentration in drinking water prescribed by the World Health Organization (WHO) was 0.07 mg/L and that prescribed by the United States Environmental Protection Agency (EPA) was 0.04 mg/L [Chem. Rev. 111, 3433 (2011)]. Suggested methods for measuring the concentration of nickel ions (Ni²⁺) in a sample containing nickel ions (Ni²⁺) include atomic absorption spectrometry [Anal. Sci. 15, 79 (1999)], ICP (ICP-MS and ICP-OES) [Microchem. J. 114, 73 (2014)], electrochemical methods [Sens. Actuators B 191, 291 (2014)], and UV-Vis optical methods [Spectrochim. Acta Part A 95, 576 (2012)].

Silver nanoprisms (AgNPRs) are produced by reducing silver nitrate (AgNO₃.H₂O) with sodium borohydride (NaBH₄) in the presence of polyvinylpyrrolidone (PVP) and trisodium citrate. These triangular, plate-like nanoprisms have been applied to various fields, including sensors, depending on their size and shape. r Nanoparticle colorimetric sensor analysis using a surface plasmon resonance phenomenon of silver nanoparticles theoretically utilizes the principle of inducing free electron vibration of the surface of nano-sized particles by means of the light waves absorbed thereto. Here, a resonance phenomenon occurs to emit a specific wavelength and result in various colors depending on the size, shape and type of the particles. Silver nanoprisms (AgNPRs) may have variable colors according to their size and shape, and thus may be applied widely to, for example, sensors for monitoring a specific material which etches the nanoprism particles.

The colorimetric sensor for detecting metal ions using silver nanoprism particles known to date is a sensor for detecting nickel ions which has been developed by Zheyu Shen, PhD and Aiguo Wu, PhD of the Chinese Academy of Sciences. They developed this sensor based on the finding that when silver nanoprism particles are combined with glutathione and iodine ions are contained in the solution, nickel ions do not etch silver nanoprisms selectively [ACS Sustainable Chem. Eng. 2016, 4, 6509-6516]. Also, Ni²⁺ ions have been selectively detected based on the finding that when silver nanoparticles are adsorbed to glutathione and then combined with Ni²⁺ ions, the maximum peak wavelength in the UV-Vis spectrum changes [Sensors and Actuators B: Chemical 143.1 (2009): 87-92]. Also, Professor Duncan Graham of Strathclyde University in the UK has used gold nanoparticles combined with EDC/Sulfo-NHS as a sensor for analyzing mercury [Small 8.5 (2012): 707-714].

However, the conventional sensors for detecting nickel ions require a separate process of modifying silver nanoprism particles. Thus, there is a need for development of sensor technology enabling to detect and analyze nickel ions (Ni²⁺) quickly and with high stability and allowing a small production.

### CITATION LIST

### Patent Literature

Patent Literature 1: Korean Patent No. 10-1406414

### Non-Patent Literature

Non-Patent Literature 1: J. Am, Dent. Assoc. 118, 449 (1989)
Non-Patent Literature 2: IARC (International Agency for Research on Cancer), 1990
Non-Patent Literature 3: Chem. Rev. 111, 3433 (2011)
Non-Patent Literature 4: Anal. Sci. 15, 79 (1999)
Non-Patent Literature 5: Microchem. J. 114, 73 (2014)
Non-Patent Literature 6: Sens. Actuators B 191, 291 (2014)
Non-Patent Literature 7: Spectrochim. Acta Part A 95, 576 (2012)
Non-Patent Literature 8: ACS Sustainable Chem. Eng. 2016, 4, 6509-6516
Non-Patent Literature 9: Sensors and Actuators B: Chemical 143.1 (2009): 87-92
Non-Patent Literature 10: Small 8.5 (2012): 707-714

### SUMMARY OF THE INVENTION

In one aspect, an object of the present disclosure is to provide a colorimetric sensor for detecting nickel ions which is excellent in selectivity, sensitivity, and stability, by using nanoprism etching.

In another aspect, an object of the present disclosure is to provide a colorimetric detection method of nickel ions which allows to conveniently detect nickel ions (Ni²⁺) contained or dissolved in soil, underground water, industrial wastewater, livestock waste, industrial waste, etc.

In one embodiment, the present disclosure provides a colorimetric sensor for detecting nickel ions, comprising silver nanoprism particles.

In another embodiment, the present disclosure provides a colorimetric detection method of nickel ions, comprising the steps of: preparing the aforementioned colorimetric sensor for detecting nickel ions; reacting the colorimetric sensor for detecting nickel ions with an assay sample; and measuring the color change of the colorimetric sensor for detecting nickel ions to detect nickel ions.

In another embodiment, the present disclosure provides a method for producing the aforementioned colorimetric sensor for detecting nickel ions, comprising the steps of: reducing an aqueous solution of silver nitrate with trisodium citrate and hydrogen peroxide in the presence of polyvinylpyrrolidone (PVP) to produce silver nanoparticles; and reducing the silver nanoparticles with sodium borohydride (NaBH₄) to produce silver nanoprism particles.

### BRIEF DESCRIPTION OF THE DRAWINGS

FIG. 1A and FIG. 1B are a schematic view (FIG. 1A) illustrating a process in which the silver nanoprism particles included in the colorimetric sensor for detecting nickel ions according to the present disclosure are etched by nickel ions (Ni²⁺) and a spectrum thereof (FIG. 1B);

FIG. 2A shows a TEM photograph and size distribution of silver nanoprism particles (before etched with nickel ions) according to an example of the present disclosure, and FIG. 2B shows a TEM photograph and size distribution of modified silver nanoprism particles in the presence of 0.2 mM Ni²⁺;

FIG. 3A and FIG. 3B show the changes in color (FIG. 3A) and a graph of absorbance ratio (A₅₀₀/A₇₅₀) (FIG. 3B) of a colorimetric sensor for detecting nickel ions according to pH change in Example 2 of the present disclosure;

FIG. 4A and FIG. 4B are a photograph of color changes (FIG. 4A) and a graph showing the absorption spectrum (FIG. 4B) of a colorimetric sensor for detecting nickel ions according to the reaction temperature after addition of nickel ions (Ni²⁺) in Example 3 of the present disclosure;

FIG. 5 is a graph showing the changes in absorbance ratio (A₅₀₀/A₇₅₀) of a colorimetric sensor solution over time according to the concentration of nickel ions (Ni²⁺) in Example 4;

FIG. 6A and FIG. 6B show a photograph of the color changes (FIG. 6A) and the absorption spectrum (FIG. 6B) of a colorimetric sensor solution when various anions and metal ions, including nickel ions, are added in Example 5;

FIG. 7A to FIG. 7C are a photograph of the color changes (FIG. 7A), a calibration curve graph of the absorbance ratio (A₅₀₀/A₇₅₀) (FIG. 7B), and a calibration curve graph of the absorption spectrum (FIG. 7C) of a colorimetric sensor solution according to the concentration of nickel ions (Ni²⁺); and

FIG. 8A and FIG. 8B show changes in color (FIG. 8A) and a graph illustrating changes in the concentration of hydrogen peroxide in a colorimetric sensor over time (FIG. 8B) when nickel ions are added to a colorimetric sensor for detecting nickel ions according to the present disclosure.

### DETAILED DESCRIPTION OF THE PREFERRED EMBODIMENTS

Throughout the specification, unless explicitly described to the contrary, the term “comprise” implies the inclusion of stated elements but not the exclusion of any other elements.

Hereinafter, embodiments of the present disclosure will be described in more detail with reference to the appended drawings. However, they are provided for illustrative purposes, and the technical idea and constitution and application of the present disclosure is not limited thereto.

Colorimetric Sensor for Detecting Nickel Ions

In exemplary embodiments, the present disclosure provides a colorimetric sensor for detecting nickel ions, comprising silver nanoprism particles.

The present disclosure is characterized in that when the colorimetric sensor of silver nanoprism reacts with a nickel ion, it changes from a triangular shape to a circular disk shape and its color changes due to local surface plasmon resonance. The silver nanoprism particle may be in the form of an aqueous solution containing distilled water and a small amount of hydrogen peroxide. Here, nickel ions serve as a catalyst for promoting the reaction of dissolved oxygen (O₂) with water molecules (H₂O) present in the aqueous solution to generate additional hydrogen peroxide (H₂O₂). The resultant hydrogen peroxide performs the etching of the nanoprisms.

In other words, the colorimetric sensor for detecting nickel ions of the present disclosure exists as an aqueous solution containing (reduced) silver nanoprism particles. When nickel ions are added to the aqueous solution in this state, the nickel ions react with oxygen, which results in a larger amount of hydrogen peroxide. The resultant hydrogen peroxide has characteristics of an oxidizing agent. Thus, the hydrogen peroxide generated by nickel ions etches the surfaces of the silver nanoprisms.

The present disclosure relates to a colorimetric sensor for detecting nickel ions (Ni²⁺). More particularly, the present disclosure allows to easily detect nickel ions by using non-modified silver triangular nanoprisms (STNs), which does not have attached to the surfaces a modifier, which requires a complicated synthesis process.

In one exemplary embodiment, the silver nanoprism particles may be non-modified particles, and may be non-modified nanoparticles.

In one exemplary embodiment, the size of the silver nanoprism particles may be between 10 and 50 nm.

In one exemplary embodiment, the silver nanoprism particles may be etched into a spherical shape by the hydrogen peroxide generated by nickel ions. Specifically, the most suitable shape of the silver nanoprism particles is a triangular disk shape. As the sharp parts of the silver nanoprism particles are etched, the prism shape changes into a spherical shape, which causes a change in a surface resonance phenomenon and thus results in a color change.

In one exemplary embodiment, the colorimetric sensor for detecting nickel ions may change in color from blue to purple, red, brown or yellow upon addition of nickel ions. Thus, the detected concentration of nickel ions (Ni²⁺) may be quantified by measuring the color change of the colorimetric sensor not only visually but also with a spectrophotometer and a colorimeter.

In one exemplary embodiment, the color emission wavelength of the colorimetric sensor for detecting nickel ions may be 600 to 900 nm, and the color emission wavelength of the detection sensor upon detection of nickel ions may be 400 to 600 nm.

In one exemplary embodiment, the colorimetric sensor for detecting nickel may detect nickel ions in the form of an aqueous solution, and the colorimetric sensor may comprise deionized water as a solvent.

In one exemplary embodiment, the pH of the colorimetric sensor for detecting nickel ions may be 6 to 9, and preferably 8. If the pH is less than 6, the colorimetric sensor may not react with nickel. If the pH is more than 9, the absorbance ratio resulting from the reaction with nickel ions may be lowered, resulting in decreased detection efficiency.

In one exemplary embodiment, the colorimetric sensor for detecting nickel ions may detect nickel ions at 20 to 35° C., preferably at 20 to 30° C. If the temperature is lower than 20° C., the colorimetric sensor may not react with nickel. If the temperature is higher than 35° C., it may be said that silver nanoprism particles do not have an effect of a colorimetric sensor due to the instability of the silver nanoprism particles, apart from nickel ions.

In one exemplary embodiment, the absorbance ratio (A₅₀₀/A₇₅₀) of the colorimetric sensor for detecting nickel ions upon detection of nickel ions may be 0.1 to 4 or 0.5 to 4.

In one exemplary embodiment, the colorimetric sensor for detecting nickel ions may further comprise a masking agent and may eliminate the incorrect interference effects of ions other than nickel ions (Ni²⁺).

Specifically, when an ionic sample causing an interference effect on the colorimetric sensor exists, a masking agent may be added to maintain selectivity to nickel ions. 100 uL of 10 mM N,N-bis(2-hydroxyethyl)-2-aminoethanesulfonic acid may be added to a sample causing interference, followed by incubation for 30 minutes to change the color to a non-responsive color. It may be a method for obtaining further selectivity for nickel ion detection by allowing to exhibit a phenomenon different from that of nickel ions.

In one exemplary embodiment, the nickel ion detection time of the colorimetric sensor for detecting nickel ions may be within 30 minutes.

In one exemplary embodiment, the detection limit of the colorimetric sensor for detecting nickel ions may be 0.1 ppm or less, 0.05 ppm or less, 0.03 ppm or less, or 0.01 ppm or less, and the colorimetric sensor for detecting nickel ions is highly suitable for colorimetric detection due to its high sensitivity.

As described above, the colorimetric sensor of the present disclosure allows to identify the content of nickel ions and has an excellent selectivity and sensitivity. Thus, it can be conveniently used for a simple method that allows measurement of the content of nickel ions (Ni²⁺) in the field. It also achieves a short reaction and detection time and thus allows immediate use in the field. Thus, it can be widely used for soil, underground water, industrial wastewater, livestock waste, and industrial sites.

Colorimetric Detection Method of Nickel Ions

In exemplary embodiments, the present disclosure provides a colorimetric detection method of nickel ions, comprising the steps of: preparing the aforementioned colorimetric sensor for detecting nickel ions; reacting the colorimetric sensor for detecting nickel ions with an assay sample; and measuring the color change of the colorimetric sensor for detecting nickel ions to detect nickel ions.

In one exemplary embodiment, in the step of reacting the colorimetric sensor for detecting nickel ions with an assay sample, one or more of the pH and temperature of the colorimetric sensor for detecting nickel ions may be adjusted.

As such, nickel ion detection can be performed by a very simple method using a colorimetric sensor for detecting nickel ions, and nickel ions can be easily detected by adjusting the stability and sensitivity of the sensor by adjusting one or more of the pH and the temperature.

Method for Producing a Colorimetric Sensor for Detecting Nickel Ions

In exemplary embodiments, the present disclosure provides a method for producing the aforementioned colorimetric sensor for detecting nickel ions, comprising the steps of: reducing an aqueous solution of silver nitrate with trisodium citrate and hydrogen peroxide in the presence of polyvinylpyrrolidone (PVP) to produce silver nanoparticles; and reducing the silver nanoparticles with sodium borohydride (NaBH₄) to produce silver nanoprism particles. Modified sensors enable to measure a variety of materials and have a high sensitivity, but generally, production of the sensors takes a long time and involves a complicated synthesis process. In contrast, the colorimetric sensor of the present disclosure does not require a separate process of modifying silver nanoprism particles, and thus allows to conveniently produce a colorimetric sensor with an excellent sensitivity and selectivity.

Hereinafter, the present disclosure will be described in detail with reference to the preferred examples so that a person skilled in the art can easily carry out the present disclosure. The present disclosure may, however, be embodied in many different forms and should not be construed as limited to the examples set forth herein.

### Production Example 1: Production of Silver Triangular Nanoprism (STN) Particles

Silver nanoprisms were produced in a 250 mL 2-neck flask.

First, 6.0 mL of 0.7 mM polyvinylpyrrolidone (PVP) was added to 99.5 mL of distilled water, 6.0 mL of 30 mM trisodium citrate (C₆H₅Na₃O₇) was added thereto, and then the mixture was stirred for 10 minutes. Then, the mixture was added with 0.5 mL of 20 mM silver nitrate (AgNO₃) and 240 μL of 30 wt % hydrogen peroxide (H₂O₂).

After sufficiently stirring the mixture at room temperature, 1.0 mL of 0.1M sodium borohydride (NaBH₄) was added so that silver ions in the solution were reduced to form silver nanoparticles. At this time, the solution turned from a transparent color to light yellow.

The solution was placed in a constant temperature water bath at 20° C. for about 80 minutes, and then it was confirmed that the nanoparticles grew into triangles. At this time, the color of the solution changed from light yellow to blue. The solution was then stored in a refrigerator at about 5° C.

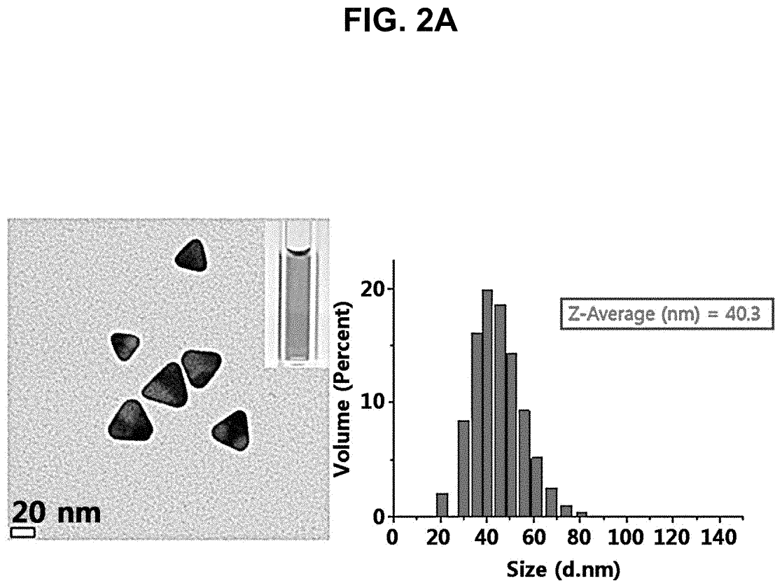

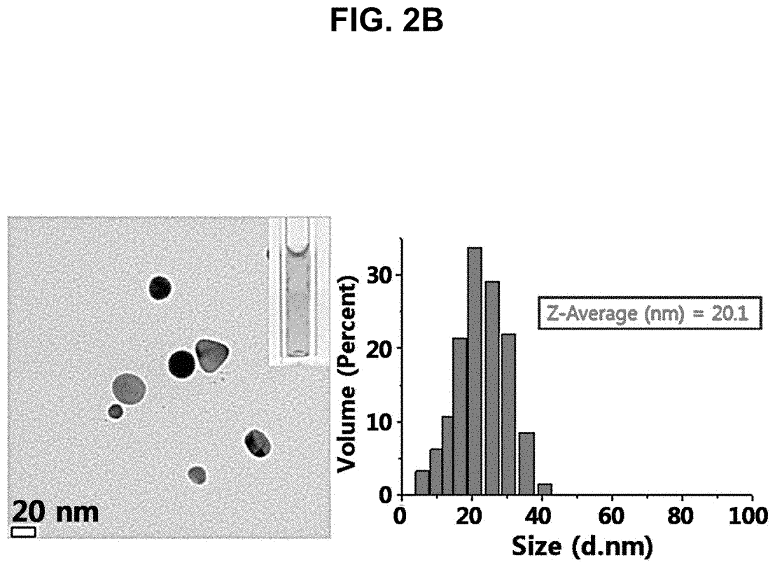

A photograph of the produced colorimetric sensor solution and a TEM photograph of the silver nanoprisms are shown in FIG. 2A. The size of the produced silver triangular nanoprism (STN) particles was up to 40 nm in width and up to 40 nm in length. The solution color change into blue is presumably due to the surface plasmon resonance of the nanoprisms.

### Example 1: Color Change Due to Ni²⁺

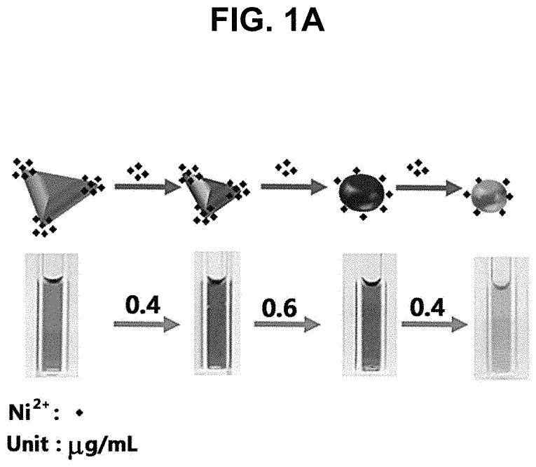

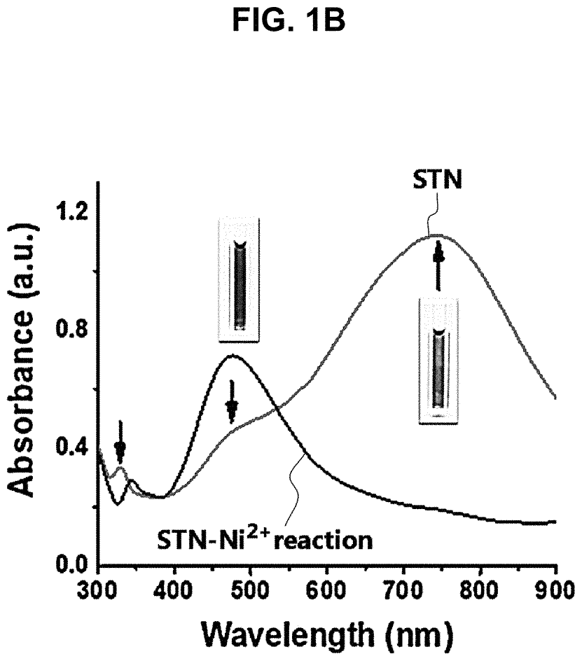

Nickel ions (Ni²⁺) were added to the colorimetric sensor solution produced in Production Example 1 so that the nickel ion (Ni²⁺) concentration became 1.4 ppm. From FIG. 1A, it can be confirmed that as the colorimetric sensor is added with a total of 1.4 pg/mL of nickel ions starting from 0.4 pg/mL of nickel ions, the color changes to purple, red, and yellow. It can also be confirmed from FIG. 1B showing the corresponding spectral change.

A color change photograph of the colorimetric sensor solution and a TEM photograph of the silver nanoprism particles are shown in FIG. 2B.

From FIG. 2B, it can be confirmed that, after addition of nickel ions (Ni²⁺), the silver nanoprism particles produced in Production Example 1 were etched so that they turned into a spherical shape and changed in color to yellow.

### Example 2: Reactivity of Silver Nanoprism Particles According to pH

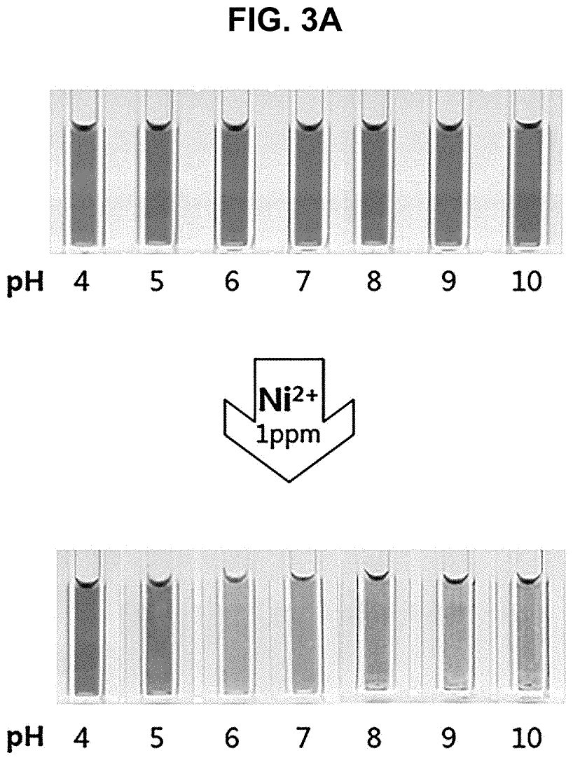

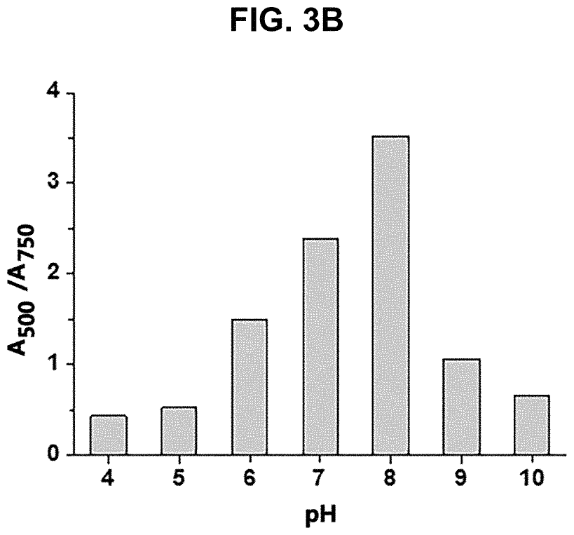

The pH of the colorimetric sensor solution obtained in Production Example 1 was adjusted to prepare samples each having a pH value of 4 to 10. 1M HNO₃ and 1M NaOH were used to adjust the pH. Then, nickel ions (Ni²⁺) were added to each sample so that the concentration of nickel ions became 1 ppm. A photograph of each sample is shown in FIG. 3A. The absorbance ratio (A₅₀₀/A₇₅₀) was measured with UV-Vis and the absorbance ratio graph is shown in FIG. 3B.

From FIG. 3A, it can be understood that at the pH of 5 or less, almost no color change occurred, indicating that silver nanoprisms did not react with nickel ions (Ni²⁺). The reaction started at pH 6, and the color turned into purple at pH 8 to 9, indicating that the silver nanoprism particles were etched into a spherical shape.

From the absorbance ratio graph of FIG. 3B, it can be understood that the absorbance was highest at pH 8 and decreased after pH 9, indicating that the colorimetric sensor solution according to the present disclosure is most reactive at pH 8.

### Example 3: Reactivity of Silver Nanoprism Particles According to Reaction Temperature

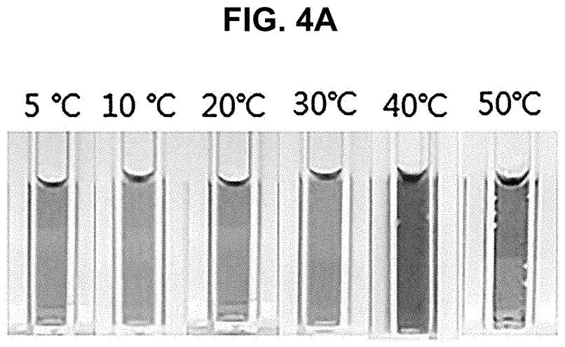

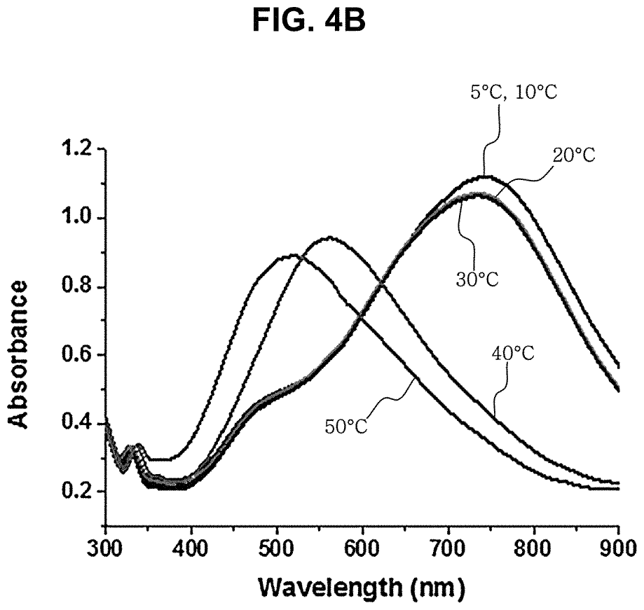

The pH of the colorimetric sensor solution obtained in Production Example 1 was adjusted to 8, and 6 samples at different temperatures of 5, 10, 20, 30, 40, and 50° C. were prepared. Each sample was reacted for 30 minutes while maintaining the temperature, and the color change was observed. The absorption spectrum of the samples are shown in FIG. 4A and FIG. 4B.

From observation of the color change, it was found that the color change as shown in FIG. 1 progresses very quickly as the reaction temperature increases.

From FIG. 4A and FIG. 4B, it can be understood that the absorbance ratio did not change greatly at 20° C. to 30° C., but increased from 40° C. This indicates that at a temperature of 40° C. or higher in the absence of nickel ions, silver nanoprism particles themselves are not stable and thus are not suitable as a colorimetric sensor. Therefore, in the present disclosure, experiments were carried out at a room temperature of 20° C. to 30° C. for accurate nickel ion (Ni²⁺) detection.

### Example 4: Reaction Time According to Nickel Ion (Ni²⁺) Concentration

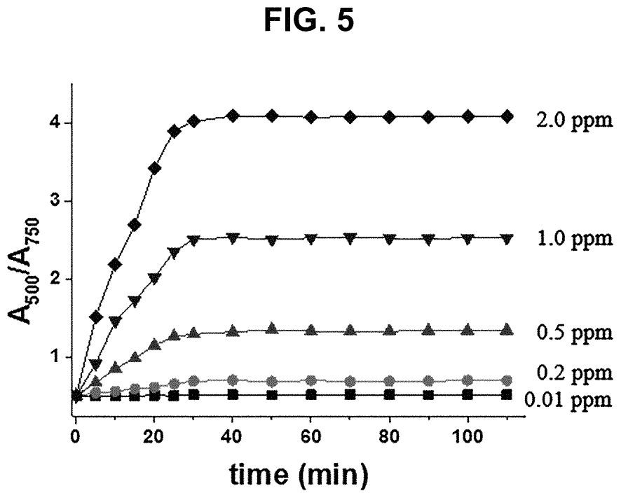

The pH of the colorimetric sensor solution obtained in Production Example 1 was adjusted to 8, and the reaction was carried out at room temperature. Nickel ions (Ni²⁺) were added to 5 samples to so that the nickel ion concentration became 0.01, 0.2, 0.5, 1.0 and 2.0 ppm, respectively. Then, the absorbance ratio (A₅₀₀/A₇₅₀) was continuously measured over time. The results are shown in FIG. 5.

From FIG. 5, it can be understood that the absorbance ratio of nickel ion (Ni²⁺) increased rapidly until 20 minutes and gradually increased from 20 minutes until 30 minutes, and that almost no reaction took place after 30 minutes. Therefore, it was confirmed that the reaction between silver nanoprism particles and nickel ions (Ni²⁺) under the above conditions is completed at about 30 minutes, and that the optimum time for detection of nickel ions (Ni²⁺) is 30 minutes after commencement of the reaction.

### Example 5: Selectivity of Colorimetric Sensor Solution to Various Ions

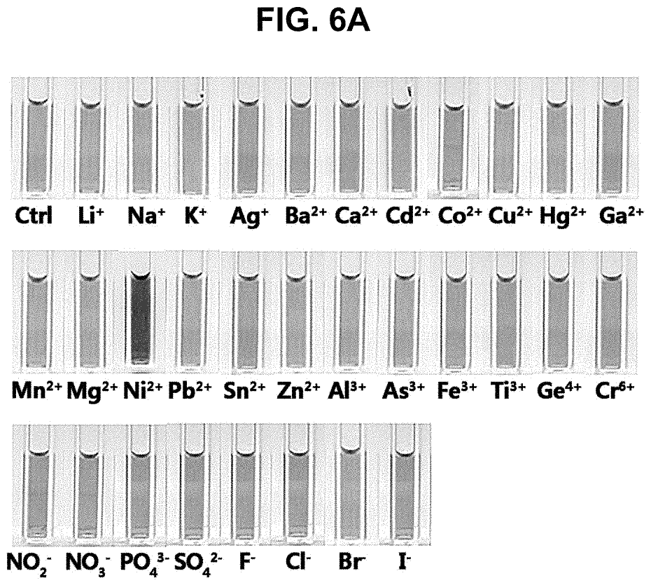

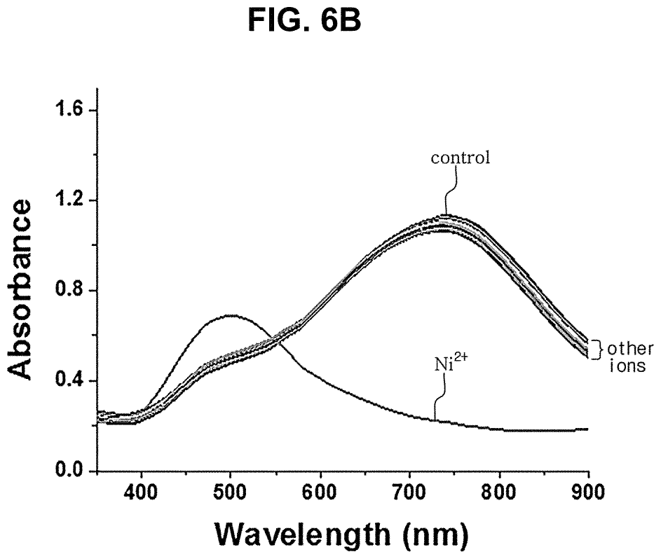

The pH of the colorimetric sensor solution obtained in Production Example 1 was adjusted to 8. Colorimetric sensor solutions of pH 8 were added with 8 types of anions (F⁻, Cl⁻, Br⁻, I⁻, NO²⁻, NO³⁻, PO₄³⁻, SO₄²⁻) and 23 types of cations (Lit, Nat, K⁺, Ag⁺, Ba²⁺, Ca²⁺, Cd²⁺, Co²⁺, Cu²⁺, Hg²⁺, Ga²⁺, Mn²⁺, Mg²⁺, Ni²⁺, Pb²⁺, Sn²⁺, Zn²⁺, Al³⁺, As³⁺, Fe³⁺, Ti³⁺, Ge⁴⁺, Cr⁶⁺) at room temperature. Then, reaction was carried out for 30 minutes and the color change was observed. FIG. 6A is a photograph of each sample after the reaction, and FIG. 6B shows UV-Vis absorption spectrum.

In FIG. 6A, the colorimetric sensor solution to which nickel ions (Ni²⁺) were added turned into red, showing a distinct difference from colorimetric sensor solutions to which other anions and metal ions were added. This indicates that an etching phenomenon on silver nanoprism particles is caused only by nickel ions (Ni²⁺).

FIG. 6B shows that the solutions to which other ions (F⁻, Cl⁻, Br⁻, I⁻, NO²⁻, NO³⁻, PO₄³⁻, SO₄²⁻, Lit, Nat, K⁺, Ag⁺, Ba²⁺, Ca²⁺, Cd²⁺, Co²⁺, Cu²⁺, Hg²⁺, Ga²⁺, Mn²⁺, Mg²⁺, Ni²⁺, Pb²⁺, Sn²⁺, Zn²⁺, Al³⁺, As³⁺, Fe³⁺, Ti³⁺, Ge⁴⁺, Cr⁶⁺) were added exhibited very similar absorption spectra to the colorimetric sensor solution, had an absorption peak at 480 nm and 750 nm, and exhibited a very strong absorbance at 750 nm (blue). In contrast, the solution to which nickel ions (Ni²⁺) were added had no absorption peak at 750 nm and exhibited an absorption peak at 500 nm (red). This indicates that it has a very excellent selectivity to nickel ions (Ni²⁺).

### Example 6: Sensitivity and Calibration Curve of Colorimetric Sensor Solution

The pH of the colorimetric sensor solutions obtained in Production Example 1 was adjusted to 8, and nickel ions (Ni²⁺) were added to the solutions so that the nickel ion concentration became 0, 0.2, 0.4, 0.6, 0.8, 1.0, 1.2, 1.4, 1.6 and 1.8 ppm, respectively. Then, reaction was carried out at room temperature for 30 minutes.

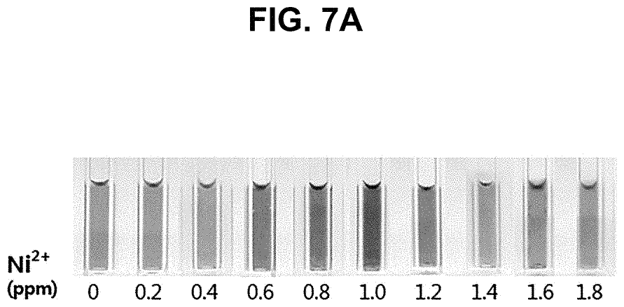

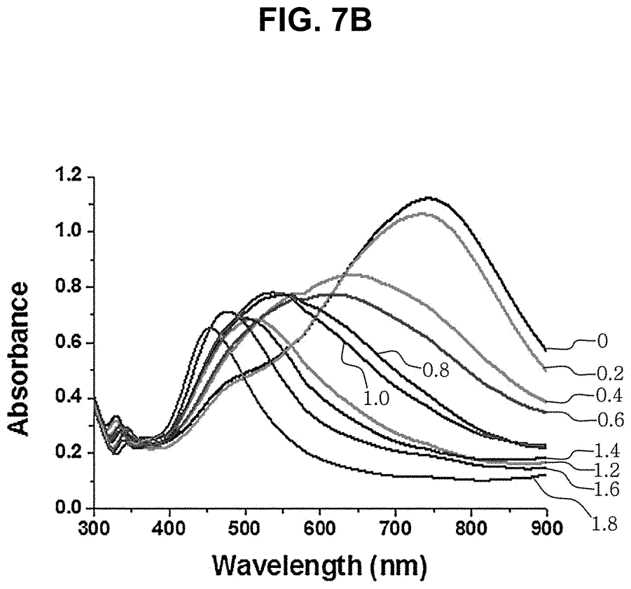

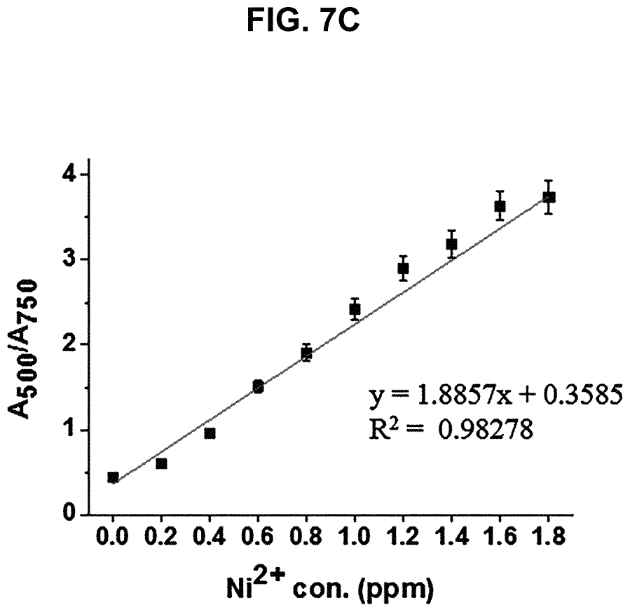

FIG. 7A is a photograph of color change according to the concentration of nickel ions (Ni²⁺) and FIG. 7B is an absorption spectrum according to the concentration of Ni²⁺ ions. From FIG. 7A, it can be seen that the color changes from blue to yellow as the concentration increases, which indicates that the colorimetric sensor in the form of a silver nanoprism is etched by nickel ions to change into a circular disk shape.

FIG. 7B and FIG. 7C show a calibration curve graph of the absorbance ratio (A₅₀₀/A₇₅₀) according to nickel ion concentration. The colorimetric sensor showed excellent results with the calibration line y=1.8857x+0.3585 and the absorption coefficient (r²)=0.9827. Table 1 below shows the detailed values of the graph of FIG. 7B.

TABLE 1

| Equation | Y = a + b * x | | |
|---|---|---|---|
| Weight | instrumental | | |
| Residual sum of | 55.92318 | | |
| squares (RSS) | | | |
| Pearson's r | 0.98278 | | |
| Adj. R-Square | 0.96158 | | |
| | | | Standard |
| | — | Value | error |
| B | Intercept | 0.35856 | 0.04918 |
| | Slope | 1.88571 | 0.12536 |

### Example 7: Validation of Colorimetric Sensor

For the experiment of detection of nickel ions (Ni²⁺) in tap water and pond water, the presence of nickel ions (Ni²⁺) in tap water and pond water was tested and the experimental validation of the present disclosure was performed. After confirmation of the absence of nickel ions (Ni²⁺), the corresponding sample was used as a blank sample.

Samples were prepared by adding nickel ions (Ni²⁺) so that the nickel ion concentration became 0.2, 1 and 2 ppm, respectively. Then, the absorbance was measured with UV-Vis. The amount detected, coefficient of variation (CV), and recovery (%) were measured using the calibration curve obtained in Example 7, and the results are shown in Table 2 below.

TABLE 2

| | Concentration | Detected | | |
|---|---|---|---|---|
| | of Ni²⁺ ions | concentration | RSD | Recovery |
| | added (uM) | (uM) | (n = 3, %) | (%) |
| Tap water | 0.2 | 0.18 ± 0.55 | 5.1 | 90.3 |
| | 1 | 0.97 ± 0.38 | 5.7 | 97.5 |
| | 2 | 2.11 ± 0.27 | 4.1 | 105.5 |
| Pond water | 0.2 | 0.18 ± 0.53 | 6.0 | 90.6 |
| | 1 | 0.89 ± 0.45 | 6.3 | 89.5 |
| | 2 | 1.85 ± 0.65 | 3.7 | 92.5 |

As shown in Table 2, the amount of nickel ions detected in samples of 0.2 ppm, 1 ppm, and 2 ppm, respectively, were 0.18±0.55, 0.97±0.38 and 2.11±0.27 for tap water, and 0.18±0.53, 0.89±0.45 and 1.85±0.65 for pond water. Thus, the detected value was very close to the actual amount added. The recovery was 90.3, 97.5 and 105.5 for tap water and 90.6, 89.5 and 92.5 for pond water. Thus, the recovery was excellent.

### Example 7: Change in the Concentration of Hydrogen Peroxide in Colorimetric Sensor Solution

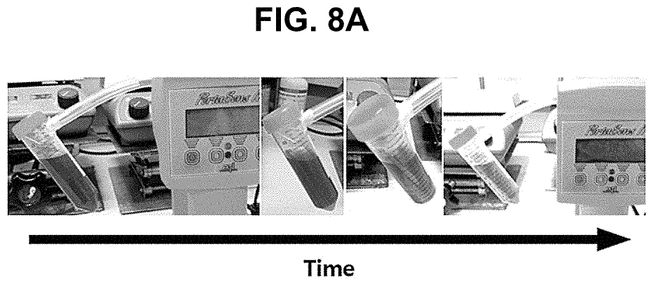

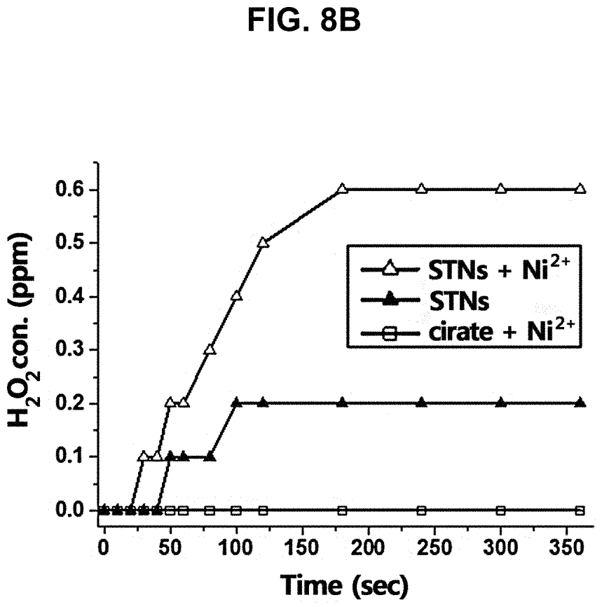

FIG. 8A is a photograph of the color change of a colorimetric sensor solution over time due to addition of nickel ions, and FIG. 8B is a graph showing the change in the concentration of hydrogen peroxide over time due to addition of nickel ions.

Specifically, FIG. 8A shows the change in color from blue to purple, brown and yellow upon addition of 20 ug/mL of Ni²⁺ ions to 35 mL of a colorimetric sensor. FIG. 8B shows the change in the concentration of hydrogen peroxide over time in the case where Ni²⁺ is added to a colorimetric sensor (STNs+Ni²⁺), in the case of a colorimetric sensor alone (STNs), and in the case where citrate and nickel ions are added (citrate+Ni²⁺). From the figure, it can be understood that the concentration of hydrogen peroxide is particularly high in the case where nickel ions are added to a colorimetric sensor (STNs+Ni²⁺). The presence of hydrogen peroxide in a colorimetric sensor alone (STNs) is believed to be attributed to the use of a small amount of hydrogen peroxide in the production of initial nanoprisms.

In general, there may be many obstacles in detecting nickel ions (Ni²⁺) in the field in real time from a product made of various compositions, such as environmental pollution samples, forensic samples, drinking water, pharmaceuticals, and industrial sites where chemicals are handled. However, it can be seen that the colorimetric sensor comprising silver nanoprisms according to the present disclosure has an excellent performance and a high selectivity.

The present disclosure uses non-modified silver nanoprisms (AgNPRs), whose surfaces have not been modified, and allows the nanoprisms to be etched selectively only by nickel ions (Ni²⁺) by adjusting pH, temperature conditions, etc., which causes a color change and thus enables to detect nickel ions easily.

Therefore, the present disclosure allows to conveniently detect nickel ions (Ni²⁺) contained or dissolved in soil, underground water, fine dust, industrial wastewater, livestock waste, industrial waste, etc. It also achieves an excellent selectivity, sensitivity and quantifying properties for nickel ions (Ni²⁺) and thus is very useful.

In addition, the present disclosure enables to detect nickel ion (Ni²⁺) at a detection limit of 0.1 ppm or less by using a simple method that allows measurement in the field, and thus has advantages of a short reaction and detection time.

The examples of the present disclosure described above should not be construed as limiting the technical idea of the present disclosure. The scope of the present disclosure is limited by only matters described in the claims, and the technical idea of the present disclosure can be modified and changed into various forms by a person skilled in the art. Accordingly, the modification and the change will belong to the scope of the present disclosure as long as the modification and change are apparent to a person skilled in the art.

What is claimed is:

1. A colorimetric sensor for detecting nickel ions, comprising silver nanoprism particles.

2. The colorimetric sensor for detecting nickel ions according to claim 1,
wherein the silver nanoprism particles are non-modified particles.

3. The colorimetric sensor for detecting nickel ions according to claim 1,
wherein the size of the silver nanoprism particles is between 10 and 50 nm.

4. The colorimetric sensor for detecting nickel ions according to claim 1,
wherein the silver nanoprism particles are etched into a spherical shape by the hydrogen peroxide generated by nickel ions.

5. The colorimetric sensor for detecting nickel ions according to claim 1,
wherein the colorimetric sensor for detecting nickel ions changes in color from blue to purple, red, brown or yellow upon addition of nickel ions.

6. The colorimetric sensor for detecting nickel ions according to claim 1,
wherein the color emission wavelength of the colorimetric sensor for detecting nickel ions is 600 to 900 nm, and the color emission wavelength of the detection sensor upon detection of nickel ions is 400 to 600 nm.

7. The colorimetric sensor for detecting nickel ions according to claim 1,
wherein the colorimetric sensor for detecting nickel ions detects nickel ions in the form of an aqueous solution.

8. The colorimetric sensor for detecting nickel ions according to claim 1,
wherein the pH of the colorimetric sensor for detecting nickel ions is 6 to 9.

9. The colorimetric sensor for detecting nickel ions according to claim 1,
wherein the colorimetric sensor for detecting nickel ions detects nickel ions at 20 to 35° C.

10. The colorimetric sensor for detecting nickel ions according to claim 1,
wherein the absorbance ratio (A₅₀₀/A₇₅₀) of the colorimetric sensor for detecting nickel ions upon detection of nickel ions is 0.1 to 4.

11. The colorimetric sensor for detecting nickel ions according to claim 1,
wherein the colorimetric sensor for detecting nickel ions further comprises a masking agent.

12. The colorimetric sensor for detecting nickel ions according to claim 1,
wherein the nickel ion detection time of the colorimetric sensor for detecting nickel ions is within 30 minutes.

13. The colorimetric sensor for detecting nickel ions according to claim 1,
wherein the detection limit of the colorimetric sensor for detecting nickel ions is 0.1 ppm or less.

14. A colorimetric detection method of nickel ions, comprising the steps of:
preparing the colorimetric sensor for detecting nickel ions according to claim 1;
reacting the colorimetric sensor for detecting nickel ions with an assay sample; and
measuring the color change of the colorimetric sensor for detecting nickel ions to detect nickel ions.

15. The colorimetric detection method of nickel ions according to claim 14,
wherein, in the step of reacting the colorimetric sensor for detecting nickel ions with an assay sample,
one or more of the pH and temperature of the colorimetric sensor for detecting nickel ions is adjusted.

16. A method for producing the colorimetric sensor for detecting nickel ions according to claim 1, comprising the steps of:
reducing an aqueous solution of silver nitrate with trisodium citrate and hydrogen peroxide in the presence of polyvinylpyrrolidone (PVP) to produce silver nanoparticles; and
reducing the silver nanoparticles with sodium borohydride (NaBH₄) to produce silver nanoprism particles.
